(19) United States
(12) Patent Application Publication
(10) Pub. No.: US 2012/0233227 A1
(43) Pub. Date: Sep. 13, 2012

(54) FILE ATTACHMENT RETRIEVAL

(75) Inventors: Michael E. Alexander, Herndon, VA (US); Jean-Claude Dispensa, La Gaude (FR); Dominique Rossi-Chevrel, La Gaude (FR); Zsolt Szalai, La Gaude (FR)

(73) Assignee: INTERNATIONAL BUSINESS MACHINES CORPORATION, Armonk, NY (US)

(21) Appl. No.: 13/227,650

(22) Filed: Sep. 8, 2011

(30) Foreign Application Priority Data
Dec. 9, 2010 (EP) 10306383.0

(51) Int. Cl. G06F 17/30; G06F 15/16

(52) U.S. Cl. 707/827; 707/E17.01

(57) ABSTRACT

Files located on local or remote storage device are retrieved by determining that a link attachment of an electronic communication received at a computer device matches a pointer of a file directory structure of the computer device. The pointer allows retrieving within the file directory structure a file link and file identification information, and then accessing a file at a local or remote storage device by the file link and using the file identification information.

### FIELD OF THE INVENTION

The present invention relates to the field of information processing, and more particularly to a method and system for easy retrieval of file attachments.

### BACKGROUND OF THE INVENTION

Electronic messaging has become an important part of business, governmental, educational, and personal communication. Users on remote computers may communicate with each other over internal and/or external networks with electronic messages, such as e-mail or using Instant Messaging (IM) tools or any other collaboration tools. A large proportion of the messages exchanged today contain attached objects representing documents, spread sheets, graphic images, sound files, executable programs, or any other type of non-text data formats.

One of the most current operations on attachments received is to store the attachments either on local storage (one or several physical repositories, including the user's local workstation's storage) or on specific communications systems storage (e-mail, IM, collaboration) servers, or on network shared storage space provided, for instance, by storage cloud services.

Sharing attachments across different computer platforms is problematic due to the multiplication of communications means and variety of storage means.

Several methods exist today for automatically detaching e-mail attachments at a mail server level, storing the attached objects into a central storage and replacing the attachments with links.

Systems for sharing storage space securely amongst users are commonly used today. However, the way to access the files is currently dependant on the tool that is used to communicate. This results in increasing time for retrieving files, which causes inefficiencies and user annoyance.

There is no consistent file access user interface within the existing collaborative tools' user interfaces for retrieving an object irrespective of its storage location. Users don't have an integrated way to manage the attached objects that were transferred using different collaborative tools such as e-mail, instant messaging, or any other collaborative tool.

To this extent, there is a need for a solution that overcomes these and other deficiencies and limitations of the prior art.

### SUMMARY OF THE INVENTION

The present invention provides a system and method for accessing attached objects of network-based transferred messages irrespective of where the objects are stored locally or remotely.

The present invention also provides a system and method for transparent and safe collaborative access to attachments irrespective of which communication application is used by the sender and receiver of the network-based transferred messages.

According to a first aspect of the present invention, there is provided a method for retrieving files located on local or remote storage device, comprising: receiving at a computer device an electronic communication comprising at least one attachment; determining that the at least one attachment is a link attachment; determining that the link attachment matches a pointer of a file directory structure of the computer device; retrieving by the pointer of the file directory structure a file link and file identification information; and accessing a file at the local or remote storage device using the file link and the file identification information.

According to a second aspect of the present invention, there is provided an apparatus comprising means adapted for carrying out each step of the method according to the first aspect of the invention.

According to a third aspect of the present invention, there is provided a computer program comprising instructions for carrying out the steps of the method when the computer program is executed on a computer.

According to a fourth aspect of the present invention, there is provided a computer readable medium having encoded thereon a computer program according to the third aspect of the invention.

Further advantages of the present invention will become clear to the skilled person upon examination of the drawings and detailed description. It is intended that any additional advantages be incorporated therein.

### BRIEF DESCRIPTION OF THE DRAWINGS

Embodiments of the present invention will now be described by way of example with reference to the accompanying drawings in which like references denote similar elements.

FIG. 1 shows a networking environment where embodiments of the present invention can be executed.

FIG. 2 shows a local file directory table in accordance with embodiments of the present invention.

FIG. 3 shows a flowchart describing a process for storing attachments from messages in accordance with embodiments of the present invention.

FIG. 4a shows a flowchart describing the process for retrieving a file from a link stored in the message in accordance with embodiments of the present invention.

FIG. 4b shows a flowchart describing the process for storing attachments from messages in remote storage in accordance with embodiments of the present invention.

FIG. 4c shows a flowchart describing the process for storing a file link from messages in accordance with embodiments of the present invention.

### DETAILED DESCRIPTION OF THE INVENTION

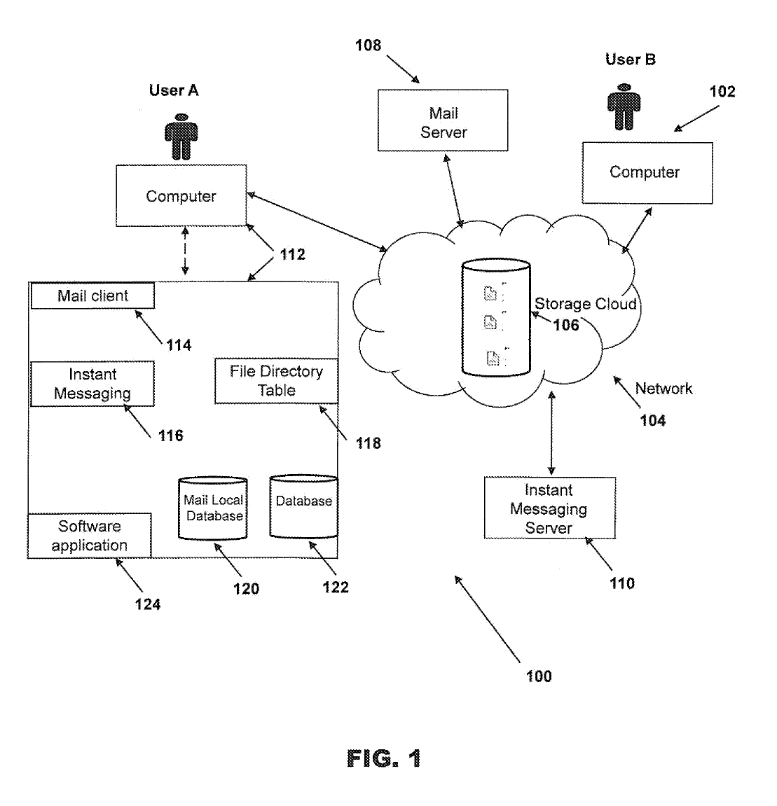

Referring to FIG. 1, there is depicted a graphical representation of a computer network environment 100 which may be utilized to implement and operate the present invention. As may be seen, computer network 100 may include a plurality of user computers 102, 112 (clients computers), operatively communicated through network 104. Network 104 is not limited to the present representation and may comprise any type of network including, inter alia, a local area network, (LAN), a wide area network (WAN), the Internet, etc. Network 104 may comprise a wireless network. Network 104 may include shared storage areas 106 provided by storage cloud service providers.

System 100 also comprises a mail server 108 and/or instant messaging server 110 connected to the user computers through network 104. Mail server 108 may comprise any type of emails with attachments. Instant messaging server 110 may comprise any type of messages with attachments. It is to be appreciated that for sake of clarity, only one mail server and one instant messaging server have been illustrated while several other collaborative messages/mails servers may exist on the network to allow mail/message communication between users computers. By convention for the present description, emails and instant messages are indifferently designated as electronic communication.

Computers 102 and 112 may comprise a single computing system or a plurality of computing systems of any type including, inter alia, a personal computer (PC), a server computer, a database computer, a computer terminal, a notebook computer, etc.

As is common, computers 102 and 112 comprise storage directory system 118, software applications 124 and storage repository 120, 122. Computers 102 and 112 are used by users for sending (senders) and receiving (recipients) emails 114 and messages 116 and for retrieving attachments from storage directory storage 118. As such, the attachments may comprise any type of file attachments including, inter alia, word processing files, PDF files, audio files, video files, picture files, compressed files, etc.

As the attachments can be located either in local or in a remote storage (cloud storage for example), several scenarios listed below may be encountered:
(1) Sending of a physical file by a sender (user B) and receipt of a physical file by one or more of recipients (user A). Taking the example of email communication, user A receives the email. The user's possible actions on the attachment may include, for example:
   (a) Keep the attachment in the local mail storage space and add it logically to a folder within the workstation's file directory;
   (b) Detach the attachment to local storage, which adds an entry in a folder within the local file directory;
   (c) Detach the attachment to remote storage and add it logically to a folder within the workstation's file directory.

The ‘Detach’ function stores the attachment into the target storage and replaces the attachment representation in the email item by a visual object (e.g., an icon) whose properties include a link to the new physical location of the object.

Characterization of the link can typically include a date and time stamp, the type of the link (Local/Remote), access credentials in the case of remote storage.
(2) Sending of a physical file by a sender (user B) and receipt of a link to a remote storage (storage cloud) by one or more recipients (user A). The operation of replacing the physical attached file by a link to a storage cloud location where the file is detached and stored has been addressed in patent application Ser. No. 12/202,466 from the Assignee which is incorporated herein by reference and is not further detailed herein. User A receives the email. The user's actions on the link contained in the email may include, for example:
   (a) Add the link logically to a folder within the user workstation's file directory;
   (b) Retrieve the file from the remote storage and add it into the user workstation's local storage. The properties of the link in the email are updated to point to the local storage.

Subsequently, the user can access the file indifferently either by going to his/her e-mail application and clicking on the visual object representing the attachment to access the attachment irrespective of where it is stored physically, or by going to its workstation file directory to access the attachment irrespective of where it is stored physically.

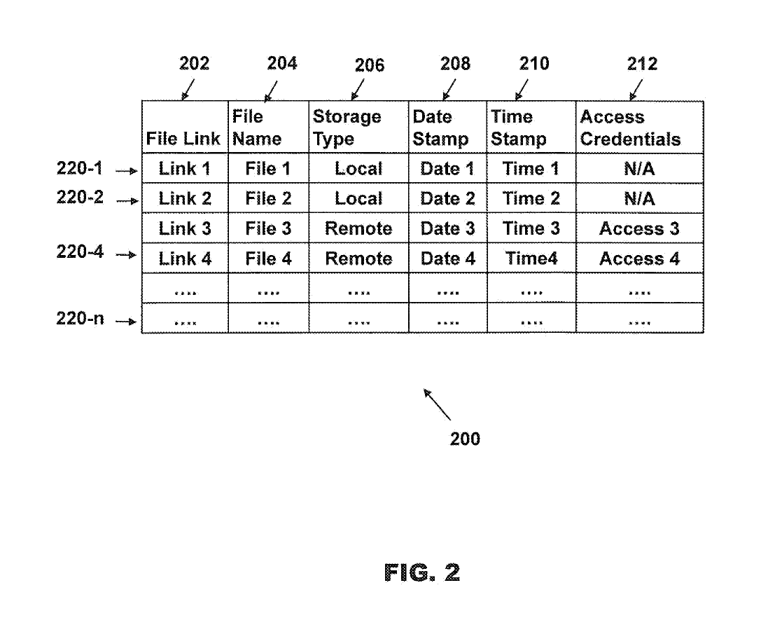

FIG. 2 illustrates a local file directory table 200, in accordance with embodiments of the present invention. Table 200 is used for storing links (column 202) to file attachments (or attached files) that have been removed from electronic communications. Table 200 may be stored in a file directory storage 118 of computers 102, 112 of FIG. 1.

A row entry 220-1, 220-2 . . . 220-n of table 200 is created and filled when a file attachment is detached from an email/message and placed in a storage location.

For each row entry 220-n, several fields represented by columns 202, 204, 206, 208, 210, 212 of file directory table 200 are filled or updated with the file attachment related information. A File Link field (202) allows entering the link to access an attachment stored on a local or a remote storage. A File Name field (204) allows entering the name of the corresponding file. A Storage Type field (206) allows indicating if the storage is local or remote. A Date Stamp field (208) and a Time Stamp field (210) contain respectively the date and time the attachment is stored in storage location. An Access Credentials field (212) allows indicating access credentials related to the user access to remote storage.

As one can appreciate, the present invention allows declaration of logical objects to a local user's file directory table, irrespective of where the physical file is stored in a remote storage location (e.g., storage cloud space 106) or in a local computer storage of the users computer (e.g., mail storage space 120 or folder storage or disk storage 122).

Referring to FIG. 3, a flow chart of a process 300 used by system 100 of FIG. 1 in accordance with embodiments of the present invention for processing attachments from emails or messages received at a recipient computer 112 is now described.

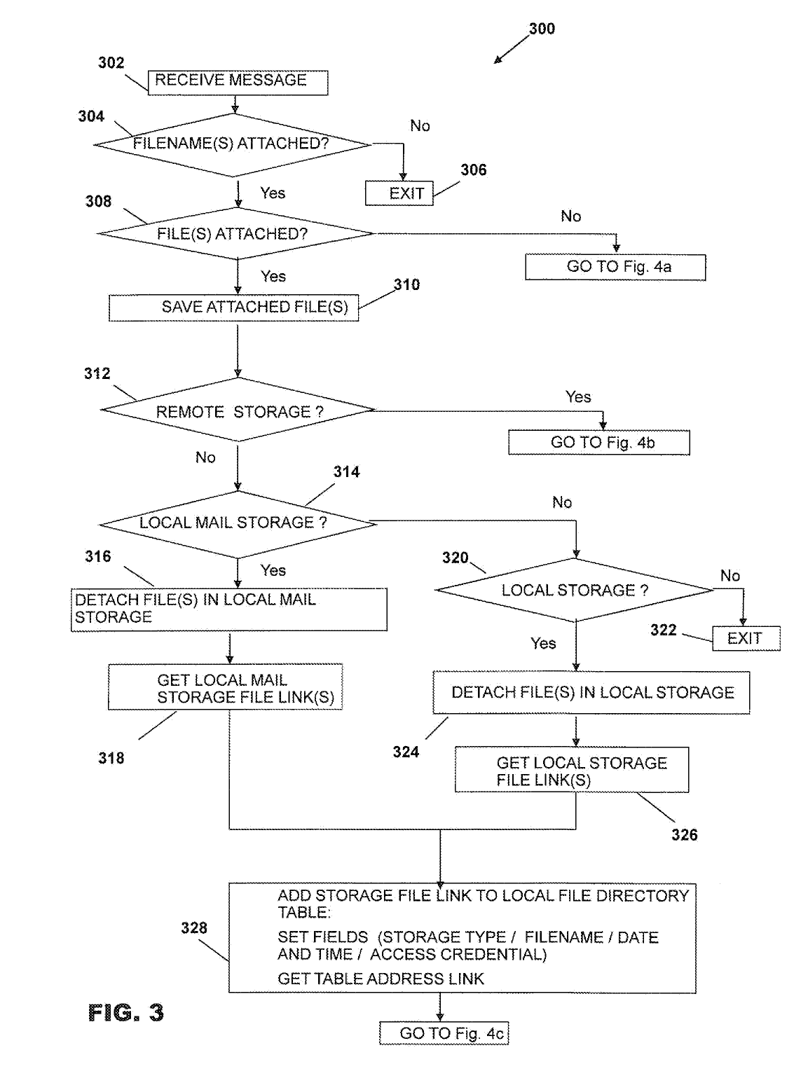

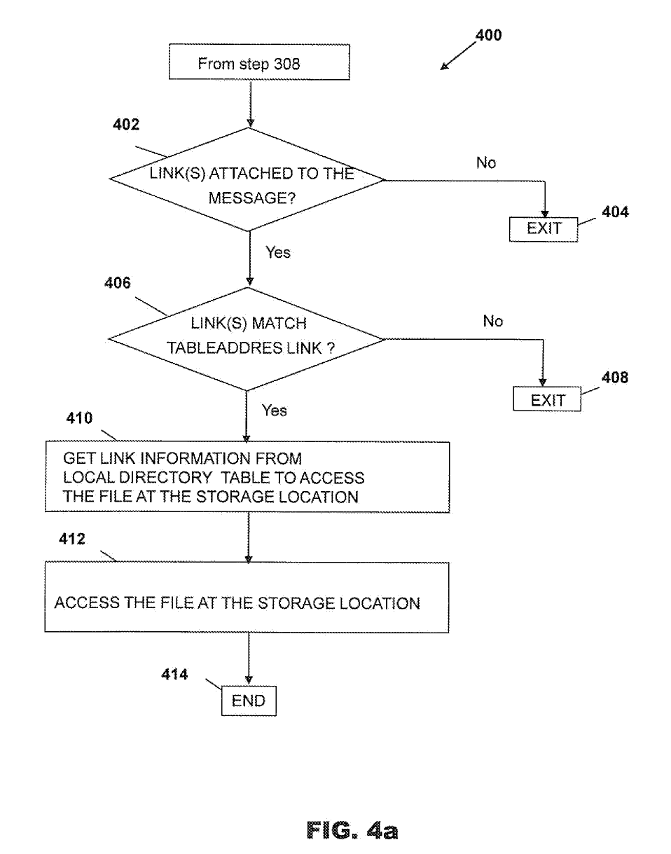

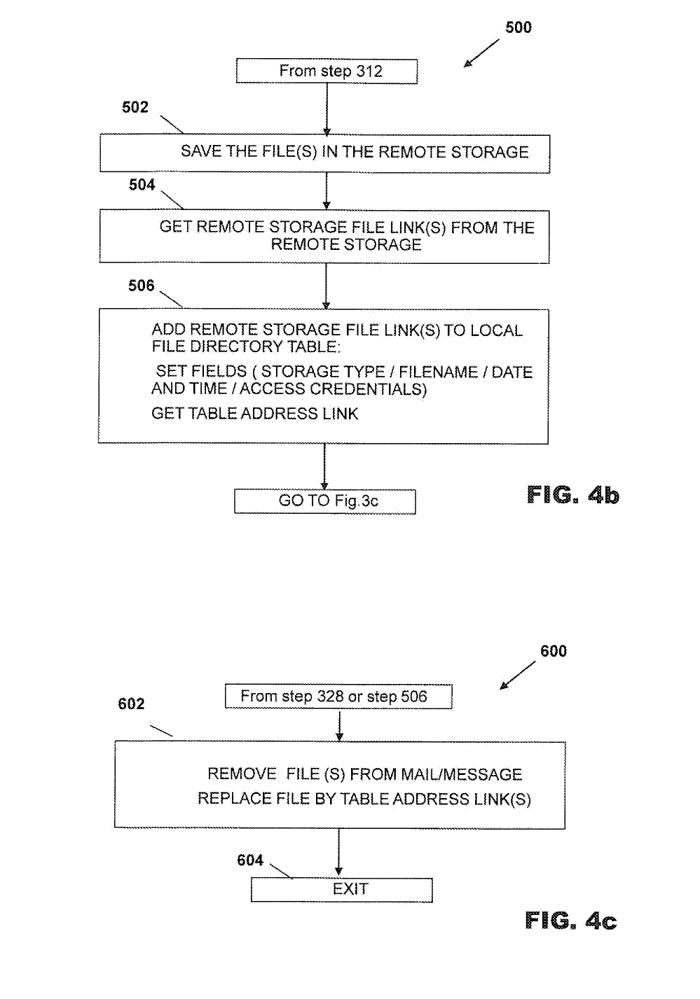

The process starts at step 302, when a computing system (e.g., computer 112 of FIG. 1) receives an electronic communication (email or instant message). In step 304, (i.e., for each electronic communication received by the computing system), a check is performed to look for a filename attachment. If in step 304, it is determined that there is no filename attachment located within the electronic communication, then the process terminates in step 306. If in step 304, it is determined that there is a filename attachment located within the electronic communication then in step 308 a check is performed to look for a physical file attachment. It is to be noted here that while not described here, the process may enter a loop of same processing for each attachment within a same electronic communication. If in step 308, it is determined that there is no file attached (branch No) then the process continues with steps as further described with reference to FIG. 4a.

If in step 308, it is determined that there is a physical file attached (branch Yes) the process continues to step 310 where the user selects to save the attached file.

Next, in step 312, the process allows choosing the storage location. If a remote storage is chosen (branch Yes), the process continues with steps that are further described with reference to FIG. 4b, otherwise the process allows for choosing for a local mail storage on step 314.

If local mail storage is chosen (branch Yes), then in step 316 the file is detached from the email or instant message, and stored into the local mail storage.

In next step 318, the link to the local mail storage is received back from the detach function.

The process continues with step 328 where the local mail storage link to the local mail storage is added in the local file directory table 200 at an assigned row entry 220-1. The different fields are filled in: Storage type is set to ‘local’; Access credentials is set to ‘0’, Filename, Date and time are filled in.

The process continues with steps as further described with reference to FIG. 4c.

Going back to step 314, if local mail storage is not chosen (branch No), the process allows for choosing for a different local storage on step 320. If the user does not choose any local storage, the process ends on step 322, otherwise the process continues with step 324.

In step 324, the file is detached from the email or instant message, and stored into the chosen local storage. This could be for instance in a local folder of the computer.

In next step 326, the link to the chosen local storage is received back from the detach function.

The process continues with step 328 where an entry in the local directory table is assigned to store information about the detached file: the local storage link is added in the corresponding row 220-2 of the local file directory table 200, and the different fields are filled in: Storage type is set to ‘local’; Access credentials is set to ‘0’, Filename, Date and Time are filled in.

The process continues with steps that are further described with reference to FIG. 4c.

Referring now to FIG. 4a, the process for retrieving an attachment from a link is described. On step 402, a check is performed to determine if a link is attached to the electronic communication. If no link is contained (branch No), the process ends on step 404.

If it is determined that a link is contained in the electronic communication (branch Yes), the process continues with a test on step 406 to check if the link matches one entry of the local file directory table 200. Matching operation allows checking if the link falls within the range of addresses already assigned in the table. If check does not point to an entry of the table (branch No), the process ends on step 408, otherwise if the check allows pointing to a matching entry of the file directory table 200, the process continues with step 410.

On step 410, information related to the matching entry is retrieved, and comprises the file link information. On next step 412, access to the corresponding file at the corresponding storage location is granted. The process ends on step 414.

Referring to FIG. 4b, the process 500 for storing an attachment in a remote storage is described. The process starts if it is determined that a remote storage is chosen by the user (branch Yes of step 312 of FIG. 3). In step 502, the process allows the user to choose the remote storage location, as in a storage cloud for example and save/detach the file in the chosen remote storage. In next step 504, the file link to the remote storage location is obtained using the ‘detach’ function.

On next step 506, an entry in the local directory table is assigned to add the remote storage link in a corresponding row entry 220-4, and the different fields are filled in: Storage type is set to ‘Remote’: Access credentials is provided; Filename, Date and Time are filled in.

The process continues with steps that are further described with reference to FIG. 4c.

FIG. 4c shows a flowchart describing the steps for replacing the attachments from emails or messages by file directory table links in accordance with embodiments of the present invention.

The process 600 applies when an entry in the file directory table 200 is created either for a local storage or a remote storage of a file attachment. On step 602, the file contained in the email or in the instant message is removed, and replaced by the corresponding address link of the file directory table.

One would easily understand that the address link may take the form of a textual link or any visual object representation (e.g., an icon) adapted for the graphical user interface of the computer.

The present invention allows a user to access a file irrespective of where it is stored physically on a local or a remote storage location, indifferently through the computer e-mail application or through the user computer file directory, simply by clicking on a visual logical object representing the attachment.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. In a computer network, a method of retrieving files located on a local or remote storage device, comprising:
receiving at a computer device an electronic communication comprising at least one attachment;
determining whether the at least one attachment is a link attachment;
in a case where the link attachment matches a pointer of a file directory structure of the computer device:
retrieving using the pointer of the file directory structure a file link and file identification information; and
accessing a file at a local or remote storage device using the file link and the file identification information.

2. The method of claim 1, wherein the electronic communication comprises an email or instant message.

3. The method of claim 1, wherein the file storage location is a remote storage device of the computer network.

4. The method of claim 1, wherein the file storage location is a local mail storage database of the computer device.

5. The method of claim 1, wherein the file identification information includes a file name and a file storage location.

6. The method of claim 5, wherein the file identification information further includes date and time storage information.

7. The method of claim 1, wherein the determining further comprises:
determining whether the at least one attachment is a file attachment; and
in the case that the at least one attachment is a file attachment:
storing the file attachment at a storage device;
receiving a storage file link identifying the file attachment and the storage device; and
using the storage file link to create a pointer of the file directory structure of the computer device.

8. The method of claim 7, further comprising:
adding file identification information of the file attachment at a location of the file directory structure pointed to by the pointer.

9. The method of claim 8, further comprising, after the adding, replacing within the electronic communication the file attachment by the pointer.

10. In a computer network, an apparatus for retrieving files located on a local or remote storage device, comprising:
a system for receiving at a computer device an electronic communication comprising at least one attachment;
a system for determining whether the at least one attachment is a link attachment;
a system for retrieving a file link and file identification information, in a case where the link attachment matches a pointer of a file directory structure of the computer device, using the pointer of the file directory structure; and
a system for accessing a file at a local or remote storage device using the file link and the file identification information.

11. The apparatus of claim 10, wherein the electronic communication comprises an email or instant message.

12. The apparatus of claim 10, wherein the file storage location is a remote storage device of the computer network.

13. The apparatus of claim 10, wherein the file storage location is a local mail storage database of the computer device.

14. The apparatus of claim 10, wherein the file identification information includes a file name and a file storage location.

15. The apparatus of claim 14, wherein the file identification information further includes date and time storage information.

16. The apparatus of claim 10, wherein the system for determining is further configured for:
determining whether the at least one attachment is a file attachment; and
in the case that the at least one attachment is a file attachment:
storing the file attachment at a storage device;
receiving a storage file link identifying the file attachment and the storage device; and
using the storage file link to create a pointer of the file directory structure of the computer device.

17. The apparatus of claim 16, further comprising:
a system for adding file identification information of the file attachment at a location of the file directory structure pointed to by the pointer.

18. The apparatus of claim 17, further comprising:
a system for replacing within the electronic communication the file attachment by the pointer.

19. A computer readable medium having encoded thereon a computer program for performing a method for retrieving files located on a local or remote storage device when the computer program is executed on a computer, the method comprising:
receiving at a computer device an electronic communication comprising at least one attachment;
determining whether the at least one attachment is a link attachment;
in a case where the link attachment matches a pointer of a file directory structure of the computer device:
retrieving using the pointer of the file directory structure a file link and file identification information; and
accessing a file at a local or remote storage device using the file link and the file identification information.
